(19) United States
(12) Patent Application Publication
(10) Pub. No.: US 2003/0195994 A1
(43) Pub. Date: Oct. 16, 2003

(54) Online collaboration method and system

(75) Inventors: William G. Burgess III, Southboro, MA (US); Grant Douglas Miller, Superior, CO (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/124,775

(22) Filed: Apr. 16, 2002

(51) Int. Cl. G06F 15/16; G06F 9/00; G06F 9/54; G06F 15/163

(52) U.S. Cl. 709/310; 709/205

(57) ABSTRACT

Members of a community work collaboratively on a task using a plurality of collaboration tools. A list of members and assigned roles is created. A central application provides the tools for each role. When a logon request and role selection is received from a member, the central application presents a menu of tools based on the list and roles selected. The member selects tools from the menu which are then automatically activated for the member's use by transferring the logon request and role section to each selected tool.

### TECHNICAL FIELD

This invention generally relates to collaboration between members of a community. More specifically the invention relates to methods and systems for activating collaboration tools for use by the members and for controlling use of the tools through member and role assignment lists.

### BACKGROUND OF THE INVENTION

Individuals having workstations which are interconnected frequently operate in a collaborative working relationship. The workstations may be interconnected either through fixed connections such as local area network (LAN), or wide area network, or they may be dynamically connected through links such as the public switched telephone network, wireless, satellite, or other communication techniques. The Internet may provide communication link for such interconnection. The type of interconnection may permit simple data exchange as well as video or sound/voice capability.

A collaborative system based on such an interconnection of workstations is a computer based environment for coordinating a plurality of individual efforts toward completion of a task. The task may involve documents, lists, designs, graphics, video, or any other activity in which individuals expend effort in a collective manner.

Tools and methods have been developed to assist individuals in performing this collaborative activity. For example, Bates et al. in U.S. Pat. No. 5,515,491 describe a tool for collaborative work on a shared data object such as a word processor document. The tool has a plurality of cursors for a plurality of users and notification regions within the document. When a cursor is moved within a designated notification region, a message is displayed to the users corresponding to that notification region.

Pacifici, in U.S. Pat. No. 6,230,171 B1 describe a tool enabling a plurality of users to annotate a shared hyper-text document using conventional web browsers. Eisenhart, in U.S. Patent Publication US2001/0047276 A1 describes a collaboration method involving storing profiles associated with members. Two profiles are compared to identify a common characteristic and if one is found, then an exchange is permitted between the corresponding two members.

Podgorny et al. in U.S. Pat. No. 6,078,948 describe a framework for forming virtual communities having virtual rooms with collaborative sessions. Other tools are available on the internet to help people to work collaboratively. These tools include real-time chat, forums or threaded discussions, chat rooms, shared calendars, shared word processor documents, and places to share applications and view presentations.

Other tools which may be used to work collaboratively include project management tools, sharing presentations, and storing and retrieving documents.

Despite the great number and variety of tools available, there is no way to tie all of these tools together in such a way that users can take effective advantage of several tools at the same time in a seamless and consistent environment. It is believed that such a capability would constitute a significant advancement in the collaboration art.

### OBJECTS AND SUMMARY OF THE INVENTION

It is therefore a principal object of the present invention to provide a capability for members of a community to collaborate using a plurality of tools. The members can move between tools without losing their relationship to each other and the community. Members may move from tool to tool without having to re-identify themselves. Additional collaboration tools including those yet to be developed, may be added to the capability for use by members.

It is another object to provide a system having such a capability.

It is yet another object to provide a method of activating collaboration tools having such a capability.

These and other objects are attained in accordance with one embodiment of the invention wherein there is provided a method of activating collaboration tools for members of a community, comprising the steps of, creating a list of members of the community in which each of the members is assigned one or more roles, providing a plurality of collaboration tools for each role, receiving a logon request and a role selection from one of the members, and in response thereto presenting a menu of the collaboration tools to the one of the members, and in response to a plurality of selections from the menu by the one of the members, activating the selected tools for the one of the members by transferring the logon request and the role selection to a directory of each selected tool.

In accordance with another embodiment of the invention there is provided a system for activating collaboration tools for members of a community, comprising, a list of members of the community in which each of the members is assigned one or more roles, a plurality of collaboration tools for each role, means for receiving a logon request and a role selection from one of the members, and in response thereto presenting a menu of the collaboration tools to the one of the members, and means for accepting a plurality of selections from the menu by the one of the members, activating the selected tools for the one of the members by transferring the logon request and the role selection to a directory of each selected tool.

### DESCRIPTION OF THE DRAWINGS

FIG. 1 is a flowchart of a method of activating collaboration tools in accordance with the present invention; and

FIG. 2 is a block diagram of a system for activating collaboration tools.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

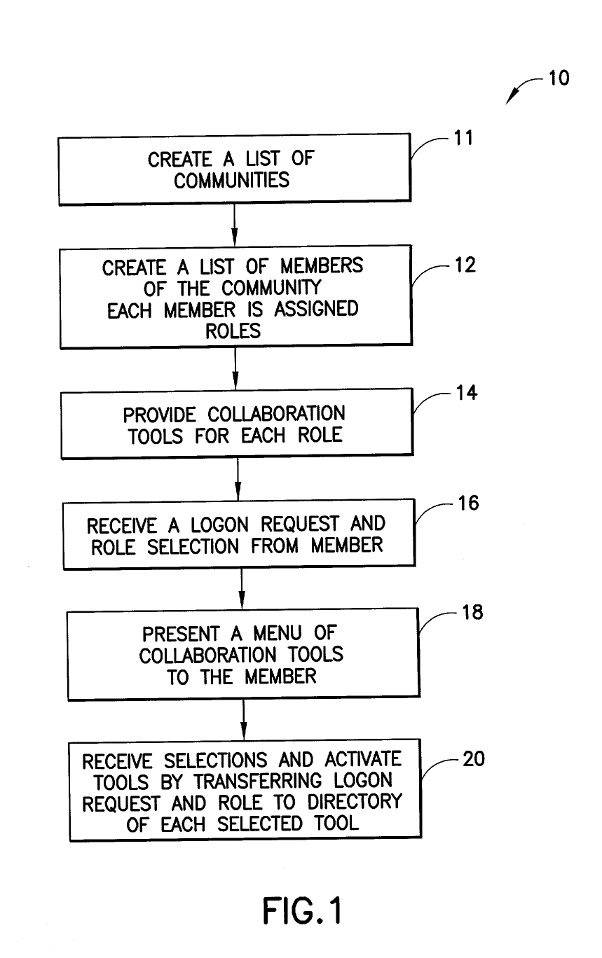

In FIG. 1 there is shown a flowchart 10 of a method of activating collaboration tools for members of a community in accordance with the present invention. In step 11, which is optional, a list of communities is created. For the case of a single community, step 11 is not needed. In step 12 a list of members of each community is created. The list includes one or more roles for each member. A community is a group of people (individuals) having a common goal or task to be accomplished. The members are the individuals who belong to the community. The list defines or identifies who is a member. There may be more than one community in which case there will be a separate list for each community. A particular individual may then be a member of more then one community. The members will work collaboratively on their common task using a variety of collaboration tools.

A role defines or specifies which tools or instances of a tool a member is permitted to use. Each member may have one or more roles as noted in the list above. Some examples of roles may include an administrator, a requester, a content creator, a viewer, an animator, an editor, a host, and an owner.

The list may be stored in a database on a processor, or within a central application running on a processor. The processor may be a server operating in a client-server mode with each member operating a client workstation.

Members may be added, removed, or have roles modified on the list by members having a role which allows access to a tool for making such changes. In other embodiments of the invention, members may select roles.

In step 14, collaboration tools are provided for each role. These tools may include instant chatting, document storage, shared calendar, forums, knowledge bases, and application sharing. One or more instances of any tool may be defined for use within a community for whatever purpose the members deem necessary. The tools may reside on the processor or server noted above. For example, people who have a creator role may create an instance of a tool. People with an owner or administrator role in a community may assign roles to other members within the community. The owner or administrator may also control which tools are available for creation of instances for members to access and use.

In step 16, a logon request to a community is received from a member including a role selection. The logon request may be received over the Internet. If the member has more than one role on the list, then more than one of these roles may be selected. The member may logon to the central application on the server using known logon techniques. The central application then presents a menu, in step 18, of collaboration tools, including instantiations of tools, which may be accessed by members having the selected role or roles.

In step 20, a plurality of tool selections by the member from the menu are received. Selections may be received by the central application. The selected tools are then activated for the member's use by transferring the logon request and role to a directory of each selected tool.

The member may then work collaboratively with other members, moving effortlessly between the selected tools and instances without having to separately logon to each tool. The member may also thereafter make additional tool selections. The logon request and role selection is then transferred to a directory of each additional tool selected, permitting further effortless movement to and from the additional tools.

As noted above, a plurality of communities may be defined by a plurality of lists kept by the central application. A second member in a different community may enter a logon request and role selection in the different community while the first member is still active, without any interference or interaction between the two members.

In the case where an individual is a member of more than one community, a separate logon request and role selection may be entered for each community. Other combinations obvious to those skilled in the art are possible without departing from the scope of the invention.

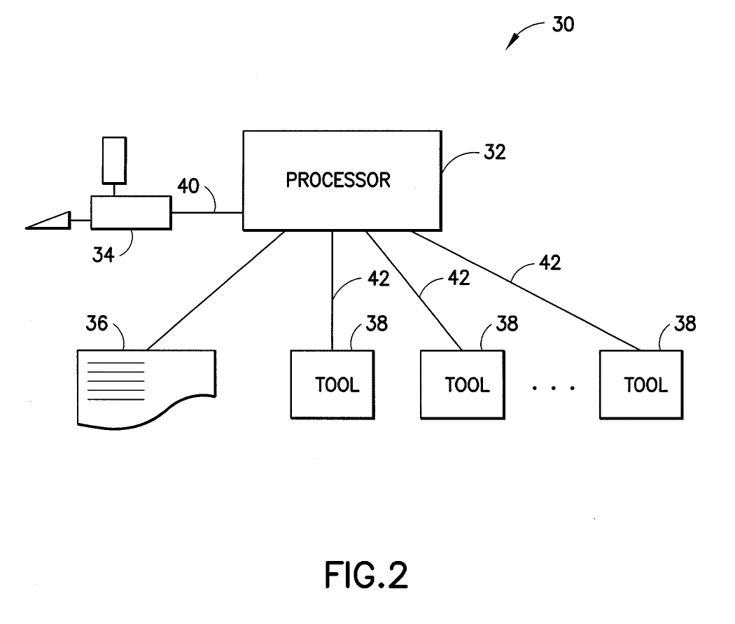

In FIG. 2 there is shown a block diagram of a system 30 for activating collaboration tools for members of a community in accordance with the present invention. List 36 of members of the community includes one or more roles for each member. The list may be entered or stored on processor 32 which may be a server. The list may be stored in a database or in a central application (not shown) on processor 32.

A plurality of collaboration tools 38 are available for use by members. Each role has a menu of collaboration tools defined for example by an owner or administrator as described above. Tools 38 may be located on processor 32 or alternatively available remotely to processor 32 over connections or links 42 as shown. The links may be a network connection or any other type of connection known in the art for making a software tool available to a processor.

Processor 32 includes means for receiving a logon request and role selection from a member of a community. The member may enter the logon request using a workstation 34 connected 40 to processor 32. Workstation 34 may be any input device known in the art including keyboard, mouse, trackball, desktop computer, laptop, handheld, palm device, client workstation or the like. It may be located adjacent processor 32 or remotely. Connection 40 may be any interconnect apparatus including network cable, fiber, dialup connection, infrared, wireless, satellite or any other type of connection. The logon request may be received by software or hardware devices or a combination within processor 32. Software may be the central application running on processor 32.

The means for receiving the logon request is also capable of presenting a menu of collaboration tools in response to the logon request and role selection received. For example, the menu may be sent to the member over connection 40 and shown on a display screen of workstation 34.

Processor 32 also includes similar means for accepting a plurality of selections from the menu by the member. Selection may be made, for example, by highlighting using a pointing device. Many other techniques known in the art for selection from a menu may be used.

In response to this menu selection, processor 32 includes a capability for transferring the received logon request and role selection to each of the selected tools, thereby making the tools available to the member. The member then interacts with the selected tools 38 directly using workstation 34 without further intervention of processor 32.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of activating collaboration tools for members of a community, comprising the steps of:
creating a list of members of said community in which each of said members is assigned one or more roles;
providing a plurality of collaboration tools for each said role;
receiving a logon request and a role selection from one of said members, and in response thereto presenting a menu of said collaboration tools to said one of said members; and
in response to a plurality of selections from said menu by said one of said members, activating the selected tools for said one of said members by transferring said logon request and said role selection to a directory of each said selected tool.

2. The method of claim 1, wherein said roles comprises an administrator, a requester, a content creator, and a viewer.

3. The method of claim 2, further comprising the step of managing said list of members by said administrator.

4. The method of claim 3, wherein said list is managed by adding or deleting members and assigning or deleting one or more roles for said members in said list.

5. The method of claim 1, wherein said logon request is received via the internet.

6. The method of claim 1, further comprising the step of thereafter adding a new member to said list of members including assigning one or more roles to said new member.

7. The method of claim 1, further comprising the step of thereafter, in response to an additional selection, activating additional selected tools for said one of said members by transferring said logon request and said role selection to a directory of each of said additional selected tools.

8. A method of activating collaboration tools for members of a plurality of communities, comprising the steps of:
creating a list of members of each of said plurality of communities in which each of said members is assigned one or more roles;
providing a plurality of collaboration tools for each said role;
receiving a logon request and a role selection from one of said members, and in response thereto presenting a menu of said collaboration tools to said one of said members; and
in response to a plurality of selections from said menu by said one of said members, activating the selected tools for said one of said members by transferring said logon request and said role selection to a directory of each said selected tool.

9. The method of claim 8, further comprising the steps of receiving a logon request and a role selection from a second of said members in a different one of said plurality of communities and in response thereto presenting a different menu of said collaboration tools.

10. A system for activating collaboration tools for members of a community, comprising:
a list of members of said community in which each of said members is assigned one or more roles;
a plurality of collaboration tools for each said role;
means for receiving a logon request and a role selection from one of said members, and in response thereto presenting a menu of said collaboration tools to said one of said members; and
means for accepting a plurality of selections from said menu by said one of said members, activating the selected tools for said one of said members by transferring said logon request and said role selection to a directory of each said selected tool.

11. The system of claim 10, wherein said roles comprises an administrator, a requester, a content creator, and a viewer.

12. The system of claim 11, wherein said list is adapted to be managed by said administrator.

13. The system of claim 12, wherein said list is adapted for adding or deleting members and assigning or deleting one or more roles for said members in said list by said administrator.

14. The system of claim 10, wherein said means for receiving a logon request further comprises means for receiving a logon request via the internet.

15. The system of claim 10, further comprising means for thereafter adding a new member to said list of members including means for assigning one or more roles to said new member.

16. The method of claim 10, further comprising means for thereafter, in response to an additional selection, activating additional selected tools for said one of said members by transferring said logon request and said role selection to a directory of each of said additional selected tools.

17. A system for activating collaboration tools for members of a plurality of communities, comprising:
a list of members of each of said plurality of communities in which each of said members is assigned one or more roles;
a plurality of collaboration tools for each said role;
means for receiving a logon request and a role selection from one of said members, and in response thereto presenting a menu of said collaboration tools to said one of said members; and
means for accepting a plurality of selections from said menu by said one of said members, and activating the selected tools for said one of said members by transferring said logon request and said role selection to a directory of each said selected tool.

18. The system of claim 17, further comprising means for receiving a logon request and a role selection from a second of said members in a different one of said plurality of communities and means for presenting in response thereto, a different menu of said collaboration tools.

19. A computer system for activating collaboration tools for members of a community, said computer system comprising:
a processor;
a list of members, on said processor, of said community in which each of said members is assigned one or more roles;
a plurality of collaboration tools for each said role, implemented on said processor;
means for receiving a logon request and a role selection from one of said members, and in response thereto presenting a menu of said collaboration tools to said one of said members; and
means for accepting a plurality of selections from said menu by said one of said members, activating the selected tools for said one of said members by transferring said logon request and said role selection to a directory of each said selected tool.

20. A computer program product for instructing a processor to activate collaboration tools for members of a community, said computer program product comprising:
a computer readable medium;
first program instruction means for creating a list of members of said community in which each of said members is assigned one or more roles;
second program instruction means for providing a plurality of collaboration tools for each said role;
third program instruction means for receiving a logon request and a role selection from one of said members, and in response thereto presenting a menu of said collaboration tools to said one of said members; and
fourth program instruction means for receiving a plurality of selections from said menu by said one of said members, and in response thereto means for activating the selected tools for said one of said members by transferring said logon request and said role selection to a directory of each said selected tool; and wherein
all said program instruction means are recorded on said medium.
